(19) United States
(12) Patent Application Publication
(10) Pub. No.: US 2016/0245076 A1
(43) Pub. Date: Aug. 25, 2016

(54) Downhole Measurement While Drilling Tool with a Spectrometer and Method of Operating Same

(71) Applicant: Evolution Engineering Inc., Calgary (CA)

(72) Inventors: Justin C. Logan, Calgary (CA); Aaron W. Logan, Calgary (CA); Gavin Gaw-Wae Lee, Calgary (CA)

(21) Appl. No.: 15/043,146

(22) Filed: Feb. 12, 2016

Related U.S. Application Data
(60) Provisional application No. 62/115,429, filed on Feb. 12, 2015.

(51) Int. Cl. E21B 47/12; E21B 4/02; G01V 8/10; E21B 47/18

(52) U.S. Cl. CPC E21B 47/123; E21B 47/124; E21B 47/18; E21B 4/02; G01V 8/10

(57) ABSTRACT

A pulser assembly for a downhole measurement-while-drilling tool comprises a motor subassembly and an electronics subassembly electrically coupled to the motor subassembly. The motor subassembly comprises a motor, a motor subassembly housing that houses the motor, a spectrometer inside the motor subassembly housing and a driveshaft extending from the motor out of the motor subassembly housing for coupling with a rotor of a fluid pressure pulse generator. The spectrometer includes an optical sensor for optical communication with a lubrication liquid when the lubrication liquid is sealed inside the motor subassembly housing. The electronics subassembly comprises electronics equipment and an electronics subassembly housing that houses the electronics equipment. Optical measurements from the spectrometer may be used to determine a molecular composition of the lubrication liquid in the downhole tool.

### PRIOR APPLICATIONS

This application claims benefit to Patent Application No. 62/115,429 filed Feb. 12, 2015, the contents of which are incorporated herein by reference.

### FIELD

This disclosure relates generally to a downhole measurement-while-drilling (MWD) tool including a spectrometer, and methods of operating such MWD tools.

### BACKGROUND

The recovery of hydrocarbons from subterranean zones relies on the process of drilling wellbores. The process includes drilling equipment situated at surface, and a drill string extending from the surface equipment to a below-surface formation or subterranean zone of interest. The terminal end of the drill string includes a drill bit for drilling (or extending) the wellbore. The process also involves a drilling fluid system, which in most cases uses a drilling “mud” that is pumped through the inside of piping of the drill string to cool and lubricate the drill bit. The mud exits the drill string via the drill bit and returns to surface carrying rock cuttings produced by the drilling operation. The mud also helps control bottom hole pressure and prevent hydrocarbon influx from the formation into the wellbore, which can potentially cause a blow out at surface.

Directional drilling is the process of steering a well from vertical to intersect a target endpoint or follow a prescribed path. At the terminal end of the drill string is a bottom-hole-assembly (“BHA”) which comprises 1) the drill bit; 2) a steerable downhole mud motor of a rotary steerable system; 3) sensors of survey equipment used in logging-while-drilling (“LWD”) and/or measurement-while-drilling (“MWD”) to evaluate downhole conditions as drilling progresses; 4) means for telemetering data to surface; and 5) other control equipment such as stabilizers or heavy weight grounding subs. The BHA is conveyed into the wellbore by a string of metallic tubulars (i.e. drill pipe).

MWD equipment is used while drilling to provide downhole sensor and status information to surface in a near real-time mode. This information is used by a rig operator to make decisions about controlling and steering the well to optimize the drilling speed and trajectory based on numerous factors, including lease boundaries, existing wells, formation properties, and hydrocarbon size and location. The rig operator can make intentional deviations from the planned wellbore path as necessary based on the information gathered from the downhole sensors during the drilling process. The ability to obtain real-time MWD data allows for a relatively more economical and more efficient drilling operation.

Known MWD tools contain essentially the same sensor package to survey the well bore; however the data may be sent back to surface by various telemetry methods. Such telemetry methods include, but are not limited to, the use of hardwired drill pipe, acoustic telemetry, use of fibre optic cable, Mud Pulse (MP) telemetry and Electromagnetic (EM) telemetry. The sensors are usually located in an electronics probe or instrumentation assembly contained in a cylindrical cover or housing, located near the drill bit.

MP telemetry involves creating pressure waves (“pulses”) in the drill mud circulating through the drill string. Mud is circulated from surface to downhole using positive displacement pumps. The resulting flow rate of mud is typically constant. The pressure pulses are achieved by changing the flow area and/or path of the mud as it passes the MWD tool in a timed, coded sequence, thereby creating pressure differentials in the mud. The pressure differentials or pulses may be either negative pulses or positive pulses. Valves that open and close a bypass mud stream from inside the drill pipe to the wellbore annulus create a negative pressure pulse. Valves that use a controlled restriction within the circulating mud stream create a positive pressure pulse. Pulse frequency is typically governed by pulse generator motor speed changes. The pulse generator motor requires electrical connectivity with the other elements of the MWD tool.

The pulse generating motor driveline system is subjected to extreme pressure differentials of up to approximately 20,000 psi between the external and internal aspects of the MWD tool when the MWD tool is downhole. To accommodate this large pressure differential, the mud is allowed access to areas of the MWD tool which are positioned on one side of a compensation mechanism. Pressure is equalized on the other side of the pressure compensation mechanism within the tool using clean lubrication liquid, such as hydraulic fluid or silicon oil. Various systems are used to provide pressure compensation including metallic bellows, rubber compensation membranes, and piston compensations with springs.

### SUMMARY

According to a first aspect there is provided a pulser assembly for a downhole measurement-while-drilling tool comprising a motor subassembly and an electronics subassembly electrically coupled to the motor subassembly. The motor subassembly comprises a motor, a motor subassembly housing that houses the motor, a spectrometer inside the motor subassembly housing comprising an optical sensor for optical communication with a lubrication liquid when the lubrication liquid is sealed inside the motor subassembly housing, and a driveshaft extending from the motor out of the motor subassembly housing for coupling with a rotor of a fluid pressure pulse generator. The electronics subassembly comprises electronics equipment and an electronics subassembly housing that houses the electronics equipment.

The electronics equipment may comprise a controller operative to read optical measurement data from the spectrometer and compare the optical measurement data to an onboard database to determine a molecular composition of the lubrication liquid. The controller may be further operative to determine when the molecular composition of the lubrication liquid has changed beyond a threshold level. The controller may be further operative to log a unique flag when the molecular composition of the lubrication liquid has changed beyond the threshold level. The controller may be further operative to transmit a unique signal when the molecular composition of the lubrication liquid has changed beyond the threshold level. The controller may be further operative to deactivate one or more operations of the measurement-while-drilling tool when the molecular composition of the lubrication liquid has changed beyond the threshold level.

The pulser assembly may further comprise a feed through connector located between the motor subassembly and electronics subassembly such that a fluid seal is established therebetween. The feed through connector may comprise: a body with a first end and an opposite second end; a receptacle in the first end which receives the spectrometer with the spectrometer facing the motor; at least one motor electrical interconnection extending axially through the body and out of the first and second ends to electrically connect the electronics equipment and the motor; and at least one spectrometer electrical interconnection extending from the spectrometer through the body and out of the second end to electrically connect the spectrometer and the electronics equipment.

The motor subassembly housing may further comprise an end with an annular shoulder in which the feed through connector is seated. A feed through seal may extend between the body and the annular shoulder such that a fluid seal is established therebetween. A receptacle seal may extend between the spectrometer and the receptacle establishing a fluid seal therebetween.

The spectrometer may be removeably mounted in the receptacle and the feed through connector may further comprise a retention clip removeably mounted in the receptacle for securing the spectrometer in place when seated in the receptacle.

The motor subassembly may further comprise a printed circuit board electrically coupled to the electronics equipment, and the spectrometer may be mounted on the printed circuit board. The motor subassembly may further comprise a motor connection block comprising at least one interconnection which extends from the motor connection block to the electronics subassembly, and the printed circuit board may be electrically coupled to the motor connection block.

According to another aspect, there is provided a motor subassembly for a pulser assembly of a downhole measurement-while-drilling tool, comprising: a housing; a motor inside the housing; a driveshaft extending from the motor and out of a driveshaft end of the housing, the driveshaft for coupling to a rotor of a fluid pressure pulse generator; and a spectrometer inside the housing and comprising an optical sensor for optical communication with a lubrication liquid when the lubrication liquid is sealed inside the housing.

The motor subassembly may further comprise a feed through connector located at an electronics end of the housing opposed to the driveshaft end of the housing. The feed through connector may comprise: a body with a first end and an opposite second end; a receptacle in the first end which receives the spectrometer with the spectrometer facing the motor; at least one motor electrical interconnection extending axially through the body and out of the first and second ends to electrically connect the motor to electronics equipment of the pulser assembly; and at least one spectrometer electrical interconnection extending from the spectrometer through the body and out of the second end to electrically connect the spectrometer and the electronics equipment. The electronics end of the housing may further comprise an annular shoulder in which the feed through connector is seated. A feed through seal may extend between the feed through connector body and the annular shoulder such that a fluid seal is established therebetween. A receptacle seal may extend between the spectrometer and the receptacle establishing a fluid seal therebetween. The spectrometer may be removeably mounted in the receptacle and the feed through connector may further comprise a retention clip removeably mounted in the receptacle for securing the spectrometer in place when seated in the receptacle.

The motor subassembly may further comprise a printed circuit board inside the housing and the spectrometer may be mounted on the printed circuit board. The motor subassembly may further comprise a motor connection block for electrical communication with electronics equipment of the pulser assembly. The motor connection block may be electrically coupled to the printed circuit board.

According to another aspect, there is provided an apparatus for a downhole measurement-while-drilling tool comprising a spectrometer and a feed through connector. The feed through connector comprises: a body with a first end and an opposite second end; a receptacle in the first end which receives the spectrometer; at least one motor electrical interconnection extending axially through the body and out of the first and second ends to electrically connect a motor to electronics equipment of the downhole measurement-while-drilling tool; and at least one spectrometer electrical interconnection extending from the spectrometer through the body and out of the second end to electrically connect the spectrometer and the electronics equipment.

A receptacle seal may extend between the spectrometer and the receptacle establishing a fluid seal therebetween.

The spectrometer may be removeably mounted in the receptacle and the feed through connector may further comprise a retention clip removeably mounted in the receptacle for securing the spectrometer in place when seated in the receptacle.

According to another aspect, there is provided a method of determining a molecular composition of a lubrication liquid in a downhole measurement-while-drilling tool having: a motor subassembly comprising a motor, a housing that houses the motor with the lubrication liquid sealed within the housing, a spectrometer inside the housing and comprising an optical sensor in optical communication with the lubrication liquid, and a driveshaft extending from the motor out of the housing for coupling with a rotor of a fluid pressure pulse generator; and electronics equipment electrically coupled to the motor subassembly. The method comprises: reading optical measurements from the spectrometer; and comparing the optical measurement from the spectrometer to an onboard database to determine the molecular composition of the lubrication liquid.

The method may further comprise determining when the molecular composition of the lubrication liquid has changed beyond a threshold level. The method may further comprise logging a unique flag in the electronics equipment when the molecular composition of the lubrication liquid has changed beyond the threshold level. The method may further comprise transmitting a unique signal when the molecular composition of the lubrication liquid has changed beyond the threshold level. The method may further comprise deactivating one or more operations of the measurement-while-drilling tool when the molecular composition of the lubrication liquid has changed beyond the threshold level.

According to another aspect, there is provided a downhole measurement-while-drilling tool comprising: the pulser assembly of the first aspect and a fluid pressure pulse generator comprising a rotor and a stator. The rotor is coupled with the driveshaft of the pulser assembly and is rotatable by the motor relative to the stator to generate fluid pressure pulses.

This summary does not necessarily describe the entire scope of all aspects. Other aspects, features and advantages will be apparent to those of ordinary skill in the art upon review of the following description of specific embodiments.

### BRIEF DESCRIPTION OF DRAWINGS

FIG. 1 is a schematic of a drill string in an oil and gas borehole comprising a MWD tool for transmission of telemetry data using pressure pulses.

FIG. 2 is a longitudinally sectioned view of a pulser assembly section of the MWD tool according to an embodiment comprising a spectrometer and feed through subassembly positioned between an electronics subassembly and a motor subassembly.

FIG. 3 is a schematic block diagram of components of the electronics subassembly of the MWD tool.

FIG. 4 is a perspective view of a low pressure end of the spectrometer and feed through subassembly shown in FIG. 2.

FIG. 5 is a perspective view of a high pressure end of the spectrometer and feed through subassembly shown in the FIG. 4.

FIG. 6 is a longitudinally sectioned view of the spectrometer and feed through subassembly shown in FIG. 4.

FIG. 7 is a longitudinally sectioned view of a motor of the MWD tool including a motor housing which houses a spectrometer according to another embodiment.

FIG. 8 is a flow chart of steps in a method for predicting life percentage of a lubrication liquid.

FIG. 9 is a flow chart of steps in a method for determining the amount of foreign particles in a lubrication liquid.

### DETAILED DESCRIPTION

Directional terms such as “uphole” and “downhole” are used in the following description for the purpose of providing relative reference only, and are not intended to suggest any limitations on how any apparatus is to be positioned during use, or to be mounted in an assembly or relative to an environment.

The embodiments described herein relate generally to a downhole measurement-while-drilling (MWD) tool including a spectrometer, and methods of operating such MWD tools.

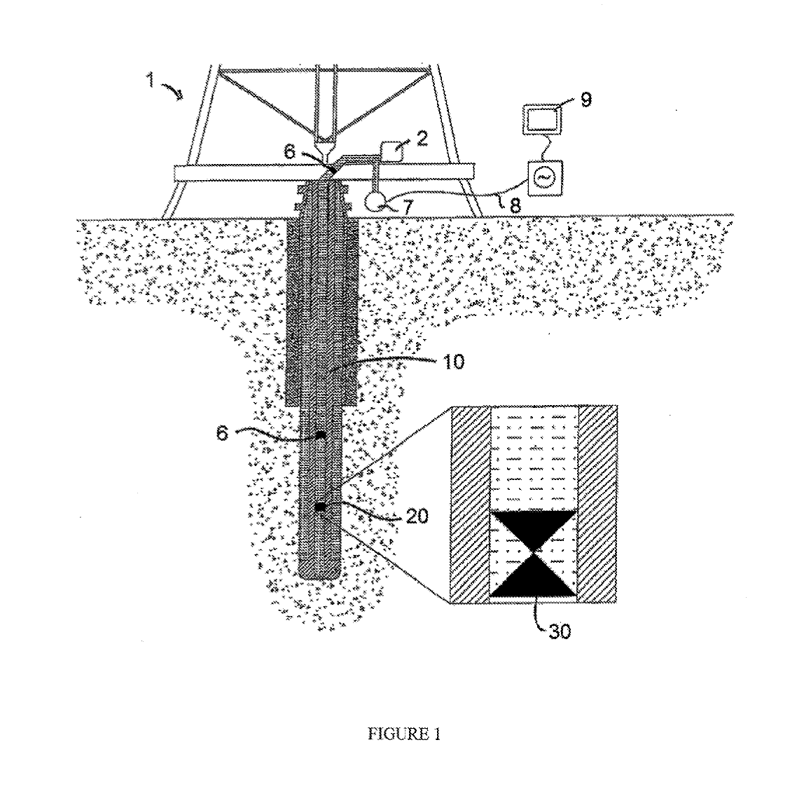

Referring to the drawings and specifically to FIG. 1, there is shown a schematic representation of a MP telemetry operation using a measurement while drilling (“MWD”) tool 20. In downhole drilling equipment 1, drilling mud is pumped down a drill string by pump 2 and passes through the MWD tool 20 which includes a fluid pressure pulse generator 30. The fluid pressure pulse generator 30 has an open position in which mud flows relatively unimpeded through the pressure pulse generator 30 and no pressure pulse is generated and a restricted flow position where flow of mud through the pressure pulse generator 30 is restricted and a positive pressure pulse is generated (represented schematically as block 6 in mud column 10). Information acquired by downhole sensors (not shown) is transmitted in specific time divisions by pressure pulses 6 in the mud column 10. More specifically, signals from sensor modules in the MWD tool 20, or in another downhole probe (not shown) communicative with the MWD tool 20, are received and processed in a data encoder in the MWD tool 20 where the data is digitally encoded as is well established in the art. This data is sent to a controller in the MWD tool 20 which then actuates the fluid pressure pulse generator 30 to generate pressure pulses 6 which contain the encoded data. The pressure pulses 6 are transmitted to the surface and detected by a surface pressure transducer 7 and decoded by a surface computer 9 communicative with the transducer by cable 8. The decoded signal can then be displayed by the computer 9 to a drilling operator. The characteristics of the pressure pulses 6 are defined by duration, shape, and frequency, and these characteristics are used in various encoding systems to represent binary data.

The MWD tool 20 generally comprises the fluid pressure pulse generator 30 and a pulser assembly which takes measurements while drilling and which drives the fluid pressure pulse generator 30. The fluid pressure pulse generator 30 and pulser assembly are axially located inside a drill collar with an annular gap therebetween to allow mud to flow through the gap. The fluid pressure pulse generator generally comprises a stator and a rotor. The pulser assembly and stator are fixed to the drill collar, and the rotor is rotated by the pulser assembly relative to the stator to generate fluid pressure pulses 6.

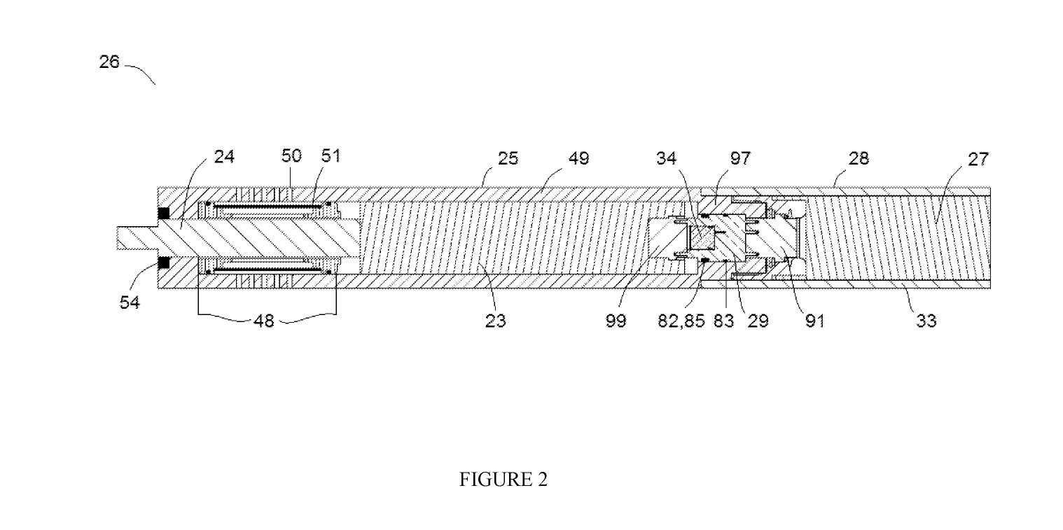

Referring to FIG. 2, the downhole end of an embodiment of a pulser assembly 26 of the MWD tool 20 is shown in more detail. The pulser assembly 26 includes a motor subassembly 25 and an electronics subassembly 28 electronically coupled together but fluidly separated by a feed-through connector 29. The motor subassembly 25 includes a motor subassembly housing 49 which houses components including a motor and gearbox assembly 23, a driveshaft 24 extending from the motor and gearbox assembly 23, and a pressure compensation device 48 surrounding the driveshaft 24. The electronics subassembly 28 includes an electronics subassembly housing 33 which is coupled to an end of the motor subassembly housing 49 and which houses downhole electronics 27 including sensors, control electronics, and other components required by the MWD tool 20 to determine the direction and inclination information and to take measurements of drilling conditions, to encode this telemetry data using one or more known modulation techniques into a carrier wave, and to send motor control signals to the motor of the motor and gearbox assembly 23 to rotate the drive shaft 24 in a controlled pattern to generate pressure pulses 6 representing the carrier wave for transmission to surface.

The motor subassembly 25 is filled with a lubrication liquid such as hydraulic oil or silicon oil, and the lubrication liquid is contained inside the motor subassembly housing 49 by a rotary seal 54 which provides a fluid seal between the driveshaft 24 and the motor subassembly housing 49. The pressure compensation device 48 comprises a flexible membrane 51 in fluid communication with the lubrication liquid on one side and with the mud on the other side via ports 50 in the motor subassembly housing 49. As is known in the art, the membrane 51 can flex to compensate for pressure changes in the mud and allow the pressure of the lubrication liquid to substantially equalize with the pressure of the mud. Without pressure compensation, the torque required to rotate the driveshaft 24 would need high current draw with excessive battery consumption resulting in increased costs. In alternative embodiments (not shown), the pressure compensation device 48 may be any pressure compensation device known in the art, such as pressure compensation devices that utilize pistons, metal membranes, or a bellows style pressure compensation mechanism.

As will be described in more detail below, a spectrometer 34 is seated inside the feed through connector 29 (collectively “spectrometer and feed through subassembly 29, 34”) and faces the inside of the motor subassembly 25. The spectrometer 34 can thus have optical access to the lubrication liquid inside the motor subassembly housing 49, and can monitor the molecular composition and condition of the lubrication liquid.

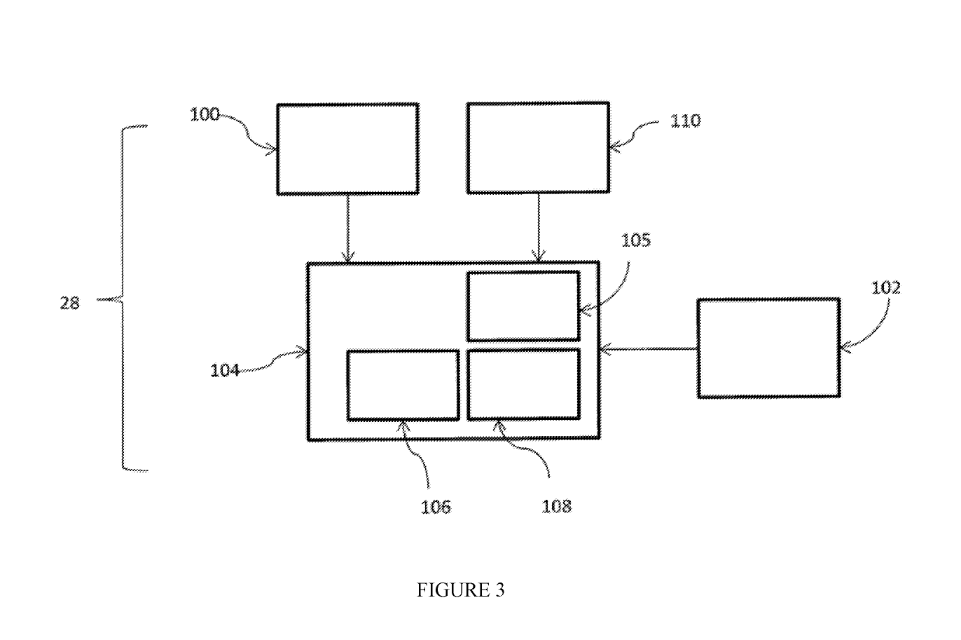

Referring now to FIG. 3, the electronics subassembly 28 includes components that determine direction and inclination of the drill string, take measurements of the drilling conditions, and encode the direction and inclination information and drilling condition measurements (collectively, “telemetry data”) into a carrier wave for transmission by the fluid pressure pulse generator 30. More particularly, the electronics subassembly 28 comprises a directional and inclination (D&I) sensor module 100, drilling conditions sensor module 102, a main circuit board 104 containing electronics equipment, as well as a battery stack 110. The main circuit board 104 comprises a data encoder 105, a central processing unit (controller) 106 and a memory 108 having stored thereon program code executable by the controller 106 and encoder 105. In alternative embodiments, other sensor modules and electronic equipment may be present as would be known to a person of skill in the art.

The D&I sensor module 100 comprises three axis accelerometers, three axis magnetometers and associated data acquisition and processing circuitry. Such D&I sensor modules are well known in the art and thus are not described in detail here.

The drilling conditions sensor module 102 includes sensors mounted on a circuit board for taking various measurements of borehole parameters and conditions such as temperature, pressure, shock, vibration, rotation and directional parameters. Such sensor modules 102 are also well known in the art and thus are not described in detail here.

The main circuit board 104 can be a printed circuit board with electronic components soldered on the surface of the board. The main circuit board 104 and the sensor modules 100, 102 may be secured on a carrier device (not shown) which is fixed inside the electronics subassembly housing 33 by end cap structures (not shown). The sensor modules 100, 102 are each electrically communicative with the main circuit board 104 and send measurement data to the controller 106. The spectrometer 34 is also electrically communicative with the main circuit board 104 and sends measurement data to the controller 106. The controller 106 processes the measurement data and the encoder 105 is programmed to encode the processed measurement data into a carrier wave using known modulation techniques. The controller 106 then sends control signals to the motor of the motor and gearbox assembly 23 to rotate the driveshaft 24 to generate pressure pulses corresponding to the carrier wave determined by the encoder 105.

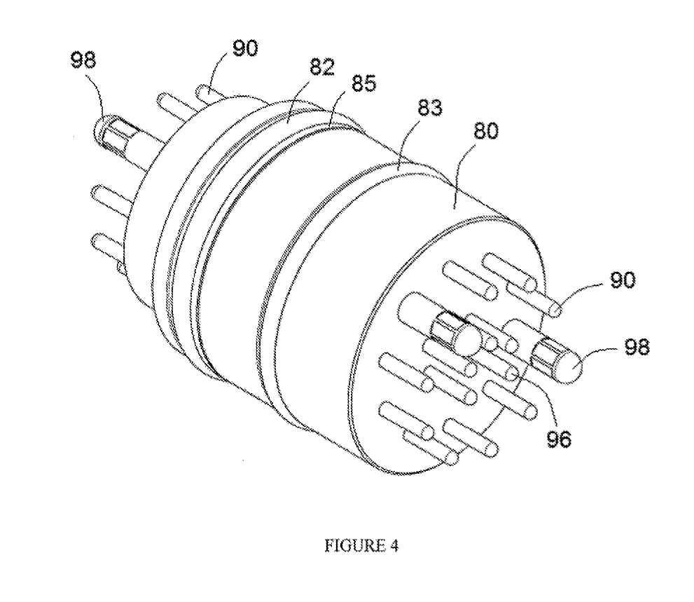

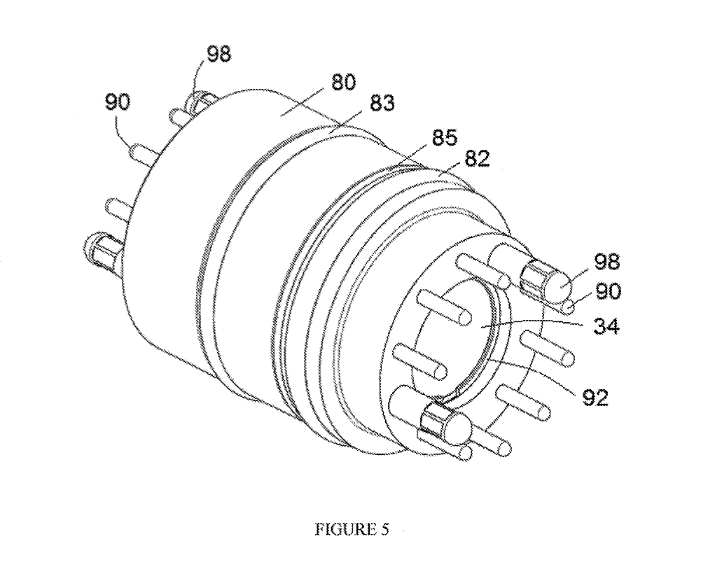

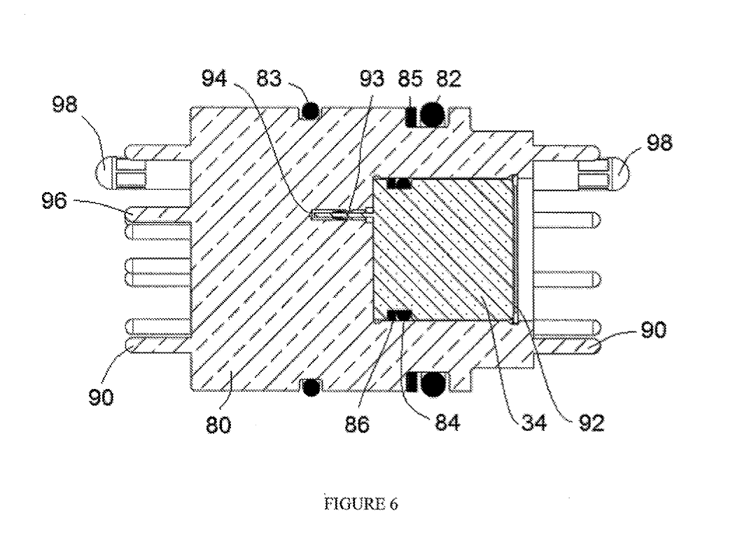

The feed through connector 29 is located between and electrically interconnects and fluidly separates the motor subassembly 25 and the electronics subassembly 28. Such feed through connectors 29 are known in the art and can be adapted for use as the spectrometer and feed through subassembly 29, 34. A suitable feed through connector 29 may therefore be custom designed or adapted from commercially available products. An embodiment of the spectrometer and feed through subassembly 29, 34 will now be described in detail with reference to FIGS. 4 to 6. The feed through connectors 29 has a body 80 which is pressure rated to withstand the pressures and pressure differentials inside the low-pressure electronics subassembly 28 (approximately atmospheric pressure) and inside the high-pressure motor subassembly 25 where pressures can reach about 20,000 psi, while still allowing electrical connectors to pass through the feed through connector 29. The body 80 has a generally cylindrical shape with a first end (“high pressure end” shown in FIG. 5) facing the inside of the motor subassembly 25 and a second end (“low pressure end” shown in FIG. 4) facing the inside of the electronics subassembly 28. The body 80 is provided with circumferential shoulders and channels on which feed through O-ring seals 82, 83 and parbak ring 85 are mounted. The feed through connector 29 also comprises electrical interconnections which extend axially through the length of the body 80 and comprise connection pins which protrude from each end of the body 80; these electrical interconnections include motor electrical interconnections with motor connection pins 90 which protrude from each end of the body 80.

The high pressure end of the body 80 includes a receptacle in which the spectrometer 34 is seated. The receptacle is located centrally in the high pressure end and has a depth that allows the spectrometer 34 to be slightly recessed in the high pressure end of the body 80 with its detection surface facing outwardly from the high pressure end of the body 80. The spectrometer 34 includes an optical sensor (not shown) which is in optical communication with the lubrication liquid in the motor subassembly 25 through the detection surface. A receptacle O-ring seal 84 and parbak ring 86 surround the spectrometer 34 and provide a fluid seal between the receptacle and the spectrometer 34. At least one spectrometer electrical interconnection extends from the spectrometer 34 through the body 80 and out of the low pressure end of the body 80 to transmit data from the spectrometer 34 to the electronics equipment in the electronics subassembly 28. In the embodiment shown in FIGS. 4 to 6, the spectrometer electrical interconnections comprise short male connection pins 93 extending from the spectrometer 34 which are received in female electrical receptacles 94 in the body 80, with the female electrical receptacles 94 electrically coupled to spectrometer connection pins 96 which extend out of the low pressure end of the body 80. A C-shaped retention clip 92 is provided to secure the spectrometer 34 in the receptacle. This retention clip 92 can be removed to allow the spectrometer 34 and its connection pins 93 to be relatively easily removed from the feed through connector 29 for servicing or replacement, without the need for soldering.

As can be seen in FIG. 2, the uphole end of the motor subassembly housing 49 is provided with an annular shoulder 97 in which the spectrometer and feed through subassembly 29, 34 is seated. The motor connection pins 90 at the high pressure end of the feed through connector 29 engage with corresponding ports of a motor electrical terminal 99 of the motor and gearbox assembly 23 and the motor connection pins 90 at the low pressure end of the feed through connector 29 engage with corresponding ports of a electronics electrical terminal 91 of the electronics subassembly 28. The motor electrical interconnections comprising motor connection pins 90 transmit power and control signals from the electronics equipment in the electronics subassembly 28 to the motor of the motor and gearbox assembly 23, as well as data from the motor back to the electronics equipment in the electronics subassembly 28. The spectrometer connection pins 96 at the low pressure end of the feed through connector 29 also engage with corresponding ports of the electronics electrical terminal 91, thereby enabling measurements from the spectrometer 34 to be transmitted to the electronics equipment in the electronics subassembly 28. Alignment pins 98 extend from the low pressure end and the high pressure end of the body 80 for correct alignment with the electrical terminals 99, 91. The feed through O-ring seals 82, 83 and parbak ring 85 contact the internal surface of annular shoulder 97 and establish a fluid seal between the feed through connector 29 and the uphole end of the motor subassembly housing 49, thereby establishing a fluid barrier between the interiors of the motor subassembly 25 and the electronics subassembly 28.

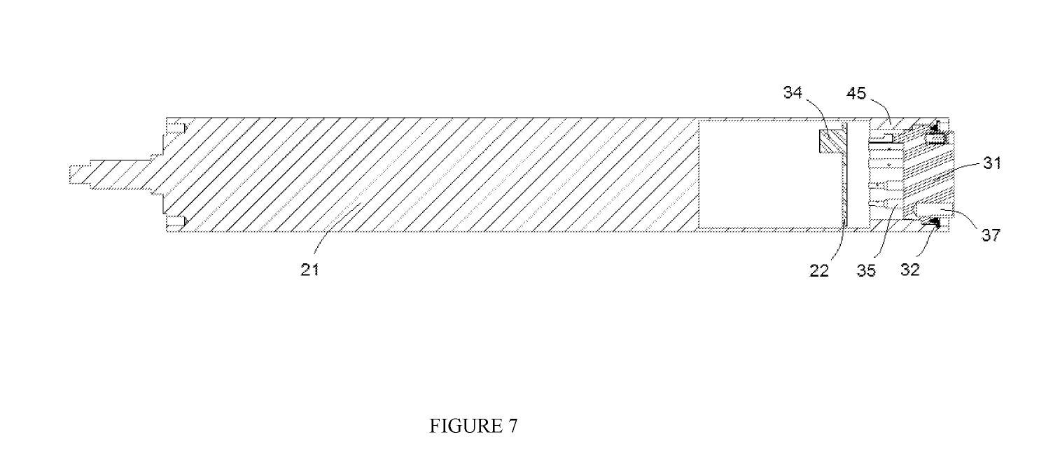

Referring now to FIG. 7, there is shown an alternative embodiment of the MWD tool 20 where the spectrometer 34 is mounted in the motor 21 of the motor and gearbox assembly 23 of the pulser assembly 26. The motor 21 includes a motor housing 45 which houses a printed circuit board 22 and motor connection block 31. Electrical receptacles 37 in the motor connection block 31 receive corresponding connection pins (not shown) extending from a feed through connector or electronics connection block of the electronics subassembly 28. The spectrometer 34 is mounted on the printed circuit board 22 with its optical sensor in optical communication with the lubrication liquid sealed within the motor subassembly 25. Solder cups 35 house wires extending between the motor 21 with printed circuit board 22 and the motor connection block 31 such that the motor 21, spectrometer 34 and other internal circuitry and sensors of the motor and gearbox assembly 23 is electrically communicative with electronics equipment in the electronics subassembly 28 via the electrical receptacles 37 and corresponding connection pins of the feed through connector or electronics connection block of the electronics subassembly 28. An O-ring surrounds the motor connection block 31 and is compressed by a retention washer and retention ring (combined “O-ring and retention washer/ring 32”). The O-ring and retention washer/ring 32 may provide a constant compression to beneficially retain the motor connection block 31 securely within the motor housing 45.

In alternative embodiments, the spectrometer 34 may be mounted anywhere within the motor subassembly housing 49 where the spectrometer's optical sensor has optical access to the lubrication liquid sealed within the motor subassembly housing 49.

The spectrometer 34 includes a light source which emits light with a wavelength from gamma to far infrared to illuminate the lubrication liquid surrounding the spectrometer 34. An optical sensor in the spectrometer 34 collects reflected light and electrically transmits this data to the controller 106 to be processed. The spectrometer 34 may be a near infrared (NIR) spectrometer as are known in the art, such as a SCiO™ sensor, which emits light in the near-infrared region of the electromagnetic spectrum (generally from about 800 nm to 2500 nm). In alternative embodiments, the light source may be a separate device and spaced from the optical sensor. In these alternative embodiments, the light source and optical sensor comprise the spectrometer 34. Without being bound by science, it is thought that molecules present in the lubrication liquid vibrate and these vibrations interact with light to create a unique optical signature. By comparing the light being emitted and the light collected the molecular content of the lubrication liquid can be analyzed.

The optical measurement data sent to the controller 106 from the spectrometer 34 will typically be too complex to transmit to the surface by telemetry. The memory 108 therefore contains program code that is executed by the controller 106 to analyze the optical measurement data received from the spectrometer 34 and compare it with an onboard database stored in the memory 108 to determine the molecular composition of the lubrication liquid. The memory 108 also contains program code that is executed by the controller 106 to utilize the determined molecular composition information to provide information on the composition and condition of the lubrication liquid. For example, the controller 106 uses the determined molecular composition information to predict the life percentage of the lubrication liquid or to determine if there are foreign particles in the lubrication liquid as described below in more detail.

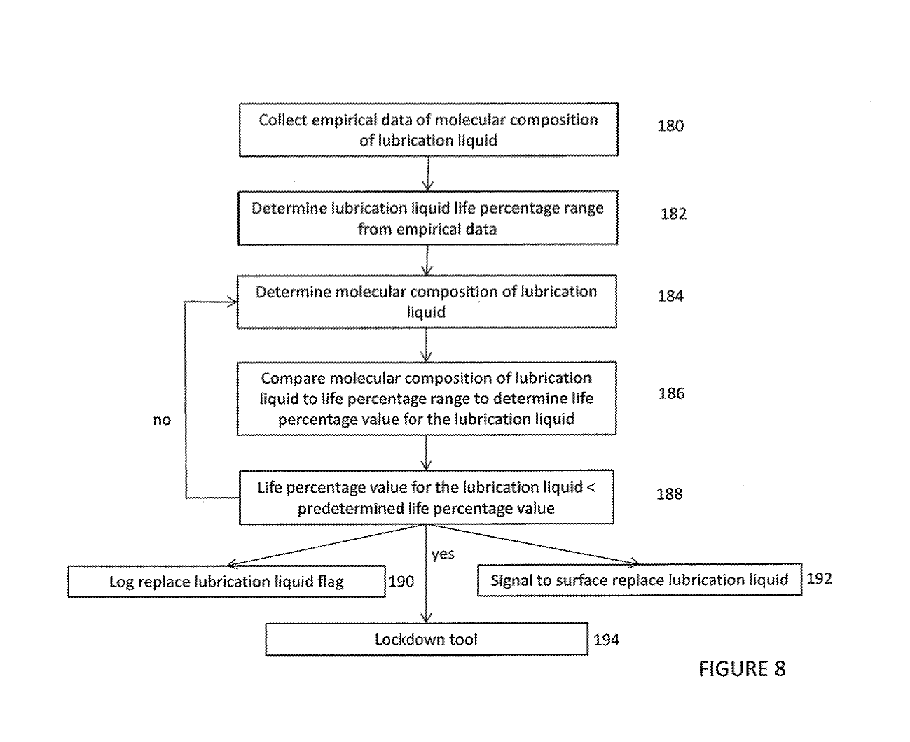

Over time, the lubrication liquid will oxidize, burn or otherwise degrade to a point where the lubrication liquid is no longer effective. The spectrometer measurement data may therefore be used to predict the life percentage of the lubrication liquid to determine when the lubrication liquid needs replacing. According to an embodiment, and referring to FIG. 8, a method for predicting life percentage of the lubrication liquid includes collecting empirical data representing the molecular composition of the lubrication liquid from the spectrometer 34 over time during servicing or calibration of the tool 20 (step 180). This empirical data is stored in the memory 108 and used by the controller 106 to determine a life percentage range for a particular lubrication liquid where 100% is fresh lubrication liquid and 0% is degraded lubrication liquid (step 182). The life percentage range for the lubrication liquid is stored in the memory 108. Alternatively, a predetermined life percentage range for the lubrication liquid is stored in the memory 108 and steps 180 and 182 need not be carried out. During operation, the controller 106 analyzes the optical measurement data received from the spectrometer 34 and compares it with the onboard database to determine the molecular composition of the lubrication liquid (step 184) in real time as described in more detail above. The controller 106 then compares the determined molecular composition of the lubrication liquid to the life percentage range to determine a life percentage value for the lubrication liquid (step 186) and assesses if the life percentage value for the lubrication liquid is less than a predetermined life percentage value (step 188). The predetermined life percentage value may be the percentage value where the lubrication liquid has degraded to a point where tool operation is affected. If the controller 106 determines that the life percentage value of the lubrication liquid is less than the predetermined life percentage value, the controller 106 logs a unique “replace lubrication liquid” flag in the memory 108 (step 190) which can be read by an operator when the tool 20 is retrieved at surface using diagnostic equipment connected to the controller 106 either wirelessly or by a hard line connection. Additionally or alternatively, the controller 106 while downhole or at surface, is programmed to send a unique signal indicating that the lubrication liquid should be replaced (step 192). The signal can be sent in the form of data communicated to the surface by a mud pulse telemetry transmission when the tool is downhole, or by some other measureable indicator such as a visual or audible indicator on the tool that can be seen or heard when the tool is retrieved at surface. Optionally, the controller 106 initiates a lockdown tool step when the life percentage value for the lubrication liquid is below the predetermined life percentage value (step 194). In some embodiments, the predetermined life percentage value for the lockdown step 194 is the same as the predetermined life percentage value for steps 190 and 192, however in alternative embodiments, steps 190 and/or 192 are initiated when the life percentage value for the lubrication liquid is below a first predetermined life percentage value, but above a second predetermined life percentage value, and the lockdown tool step 194 is initiated when the life percentage value for the lubrication liquid is below the second predetermined life percentage value, with the second predetermined life percentage value being lower than the first predetermined life percentage value. The lockdown tool step deactivates the MWD tool 20 thereby preventing the MWD tool 20 from being inadvertently used before the primary seal 54, pressure compensation device 48, or the lubrication liquid is replaced, which may prevent a potential failure.

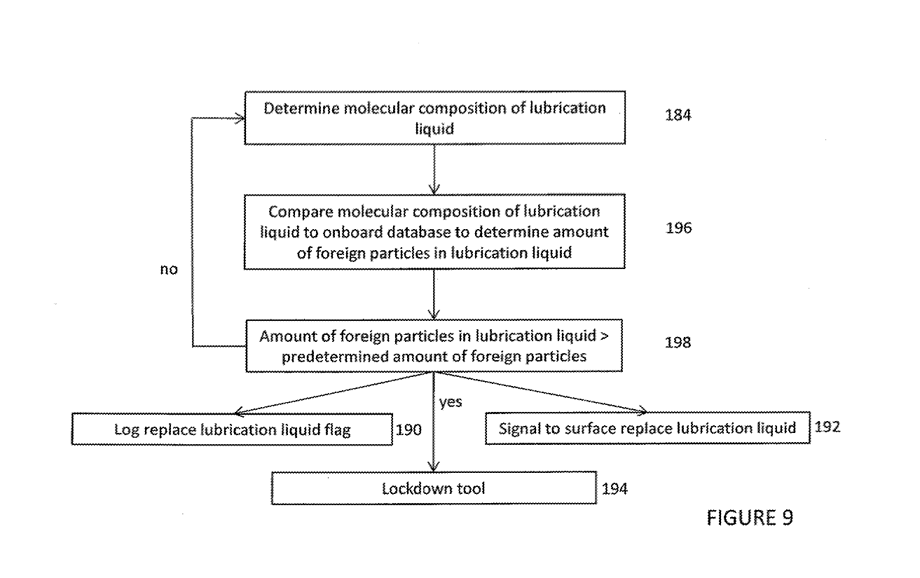

There may be a build up of foreign particles in the lubrication liquid over time which can affect the quality of the lubrication liquid. Such foreign particles may, for example, include excessive carbon build up as the lubrication liquid becomes carburized due to high electrical currents present in the motor subassembly 25. Other foreign particles which may be present in the lubrication liquid include metal filings or drilling mud that has seeped into the lubrication liquid through failure of the seal 54 or the pressure compensation device 48. According to an embodiment, and referring to FIG. 9, a method for determining the amount of foreign particles in the lubrication liquid includes analyzing the optical measurement data received from the spectrometer 34 and comparing it with the onboard database to determine the molecular composition of the lubrication liquid (step 184) as described in more detail above. The controller 106 then compares the determined molecular composition of the lubrication liquid to molecular composition information stored on an onboard database in the memory 108 to determine the amount of foreign particles in the lubrication liquid (step 196) and assesses if the amount of foreign particles in the lubrication liquid is more than a predetermined amount of foreign particles (step 198). If the controller 106 determines that the amount of foreign particles in the lubrication liquid is more than a predetermined amount of foreign particles, the controller 106 logs a unique “replace lubrication liquid” flag in the memory 108 (step 190) as described above in more detail. Additionally or alternatively, the controller 106 while downhole or at surface, is programmed to send a unique signal indicating that the lubrication liquid should be replaced (step 192) as described above in more detail. The controller 106 may also initiate a lockdown tool step (step 194) when the amount of foreign particles in the lubrication liquid is more than a predetermined amount of foreign particles as described above in more detail. In some embodiments, the predetermined amount of foreign particles for the lockdown step 194 is the same as the predetermined amount of foreign particles for steps 190 and 192. In alternative embodiments, steps 190 and 192 are initiated when the amount of foreign particles in the lubrication liquid is above a first predetermined amount of foreign particles but below a second predetermined amount of foreign particles, and the lockdown tool step 194 is initiated when the amount of foreign particles in the lubrication liquid is above the second predetermined amount of foreign particles, with the second predetermined amount of foreign particles being higher than the first predetermined amount of foreign particles.

While particular embodiments have been described in the foregoing, it is to be understood that other embodiments are possible and are intended to be included herein. It will be clear to any person skilled in the art that modifications of and adjustments to the foregoing embodiments, not shown, are possible. For example, in alternative embodiments (not shown), the fluid pressure pulse generator 30 may be positioned at the uphole end of the MWD tool 20.

1. A pulser assembly for a downhole measurement-while-drilling tool comprising:
(a) a motor subassembly comprising a motor, a motor subassembly housing that houses the motor, a spectrometer inside the motor subassembly housing and comprising an optical sensor for optical communication with a lubrication liquid when the lubrication liquid is sealed inside the motor subassembly housing, and a driveshaft extending from the motor out of the motor subassembly housing for coupling with a rotor of a fluid pressure pulse generator; and
(b) an electronics subassembly electrically coupled to the motor subassembly and comprising electronics equipment and an electronics subassembly housing that houses the electronics equipment.

2. The pulser assembly of claim 1, wherein the electronics equipment comprises a controller operative to read optical measurement data from the spectrometer and compare the optical measurement data to an onboard database to determine a molecular composition of the lubrication liquid.

3. The pulser assembly of claim 2, wherein the controller is further operative to determine when the molecular composition of the lubrication liquid has changed beyond a threshold level.

4. The pulser assembly of claim 3, wherein the controller is further operative to log a unique flag when the molecular composition of the lubrication liquid has changed beyond the threshold level.

5. The pulser assembly of claim 3, wherein the controller is further operative to transmit a unique signal when the molecular composition of the lubrication liquid has changed beyond the threshold level.

6. The pulser assembly of claim 3, wherein the controller is further operative to deactivate one or more operations of the measurement-while-drilling tool when the molecular composition of the lubrication liquid has changed beyond the threshold level.

7. The pulser assembly of claim 1 further comprising a feed through connector located between the motor subassembly and electronics subassembly such that a fluid seal is established therebetween, the feed through connector comprising:
a body with a first end and an opposite second end;
a receptacle in the first end which receives the spectrometer with the spectrometer facing the motor;
at least one motor electrical interconnection extending axially through the body and out of the first and second ends to electrically connect the electronics equipment and the motor; and
at least one spectrometer electrical interconnection extending from the spectrometer through the body and out of the second end to electrically connect the spectrometer and the electronics equipment.

8. The pulser assembly of claim 7, wherein the motor subassembly housing further comprises an end with an annular shoulder in which the feed through connector is seated.

9. The pulser assembly of claim 8 further comprising a feed through seal extending between the body and the annular shoulder such that a fluid seal is established therebetween.

10. The pulser assembly of claim 7 further comprising a receptacle seal extending between the spectrometer and the receptacle and establishing a fluid seal therebetween.

11. The pulser assembly of claim 7, wherein the spectrometer is removeably mounted in the receptacle and the feed through connector further comprises a retention clip removeably mounted in the receptacle for securing the spectrometer in place when seated in the receptacle.

12. The pulser assembly of claim 1, wherein the motor subassembly further comprises a printed circuit board electrically coupled to the electronics equipment, and the spectrometer is mounted on the printed circuit board.

13. The pulser assembly of claim 12, wherein the motor subassembly further comprises a motor connection block comprising at least one interconnection which extends from the motor connection block to the electronics subassembly, and the printed circuit board is electrically coupled to the motor connection block.

14. A motor subassembly for a pulser assembly of a downhole measurement-while-drilling tool, comprising:
(a) a housing;
(b) a motor inside the housing;
(c) a driveshaft extending from the motor and out of a driveshaft end of the housing, the driveshaft for coupling to a rotor of a fluid pressure pulse generator; and
(d) a spectrometer inside the housing and comprising an optical sensor for optical communication with a lubrication liquid when the lubrication liquid is sealed inside the housing.

15. The motor subassembly of claim 14 further comprising a feed through connector located at an electronics end of the housing opposed to the driveshaft end of the housing, the feed through connector comprising:
a body with a first end and an opposite second end;
a receptacle in the first end which receives the spectrometer with the spectrometer facing the motor;
at least one motor electrical interconnection extending axially through the body and out of the first and second ends to electrically connect the motor to electronics equipment of the pulser assembly; and
at least one spectrometer electrical interconnection extending from the spectrometer through the body and out of the second end to electrically connect the spectrometer and the electronics equipment.

16. The motor subassembly of claim 14, wherein the motor subassembly further comprises a printed circuit board inside the housing and the spectrometer is mounted on the printed circuit board.

17. An apparatus for a downhole measurement-while-drilling tool comprising a spectrometer and a feed through connector, the feed through connector comprising:
a body with a first end and an opposite second end;
a receptacle in the first end which receives the spectrometer;
at least one motor electrical interconnection extending axially through the body and out of the first and second ends to electrically connect a motor to electronics equipment of the downhole measurement-while-drilling tool; and
at least one spectrometer electrical interconnection extending from the spectrometer through the body and out of the second end to electrically connect the spectrometer and the electronics equipment.

18. A method of determining a molecular composition of a lubrication liquid in a downhole measurement-while-drilling tool having: a motor subassembly comprising a motor, a housing that houses the motor with the lubrication liquid sealed within the housing, a spectrometer inside the housing and comprising an optical sensor in optical communication with the lubrication liquid, and a driveshaft extending from the motor out of the housing for coupling with a rotor of a fluid pressure pulse generator; and electronics equipment electrically coupled to the motor subassembly, the method comprising:
(a) reading optical measurements from the spectrometer; and
(b) comparing the optical measurement from the spectrometer to an onboard database to determine the molecular composition of the lubrication liquid.

19. The method of claim 18 further comprising determining when the molecular composition of the lubrication liquid has changed beyond a threshold level.

20. The method of claim 19 further comprising logging a unique flag in the electronics equipment when the molecular composition of the lubrication liquid has changed beyond the threshold level.

21. The method of claim 19 further comprising transmitting a unique signal when the molecular composition of the lubrication liquid has changed beyond the threshold level.

22. The method of claim 19 further comprising deactivating one or more operations of the measurement-while-drilling tool when the molecular composition of the lubrication liquid has changed beyond the threshold level.
